(19) United States
(12) Patent Application Publication
(10) Pub. No.: US 2010/0088372 A1
(43) Pub. Date: Apr. 8, 2010

(54) CONFERENCE NETWORKING SYSTEM INCORPORATING SOCIAL NETWORKING SITE INFORMATION

(75) Inventors: Shishir Shridhar, Redmond, WA (US); Dharmesh P. Singh, Sammamish, WA (US); Kintan D. Brahmbhatt, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,277

(22) Filed: Oct. 3, 2008

(51) Int. Cl. G06F 15/16

(52) U.S. Cl. 709/204

(57) ABSTRACT

A method for facilitating networking among attendees at a conference is provided. The method includes receiving over a wide-area network a user profile from a user who has registered for at least one conference selected from among a plurality of conferences. The user profile includes a username for at least one social networking site. The user profile is stored in a database that includes a plurality of user profiles for a plurality of attendees who have registered for at least one of the plurality of conferences. The user is granted access to the database over the wide-area network, including access to a profile on the social networking site associated with the username.

### BACKGROUND

Conventions, conferences and similar events involve convergence of hundreds or thousands of attendees, potentially from all over the world. These events represent excellent opportunities to meet people in a profession, expand personal and professional networks, and renew or strengthen existing contacts. However, conventions are also typically a sea of people, making the process of locating a particular individual and achieving contact a potentially difficult process. Such technologies as the physical bulletin board and a paper copy of attendees have been used over the years, with limited success. An attendee may or may not see the bulletin board, and contact information for attendees may not be useful while at the conference. Similarly, determining what events at a convention are available for sign-up—whether updated, cancelled or added, may be useful to attendees. For example, a change in room or time of an event can be vital for those wishing to attend. Similarly, an added meeting for a hot topic can be useful—if people know about it.

One system that has been designed to solve this problem issues paper tickets for each event. This system requires the attendee to walk to the desired event or attraction prior to the actual scheduled time in order to acquire the ticket. This system is not real-time for the attendee and does not give any information on the real-time status of events and attractions. Another system involves a wireless system to schedule appointments. However, this system utilizes cumbersome computers at each attraction, thereby increasing cost and decreasing the performance efficiency. Requiring use of dedicated terminals can be difficult for convention attendees who may have their own devices with them.

Yet another system provides real-time event information, customized advertising to conference attendees over wireless networks using personal digital assistants (PDAs) and laptops. One problem with this system is that attendees must complete a user profile that does not encompass the full range of information that attendees may wish to include about themselves and their friends and associates.

### SUMMARY OF THE INVENTION

A method and system is provided for facilitating networking among attendees at a conference. In one illustrative example, conference attendees may establish on-line user profiles of themselves, which they may share with other attendees prior to the conference. The user profiles of individual users may include access to other profiles of these same users which are established on any of a variety of social networking sites. In this way conference attendees can leverage the power of social networking tools to discover, connect and collaborate with other attendees prior to, during and after the conference. A search engine may be provided so that attendees can search the user profiles of other attendees, including the profiles located on the social networking sites. A recommendations engine may also be provided to recommend various events and activities to the attendees based on their user profiles.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows one example of a screen shot of a web page that may be presented to an attendee who is registering for an on-line conference networking service.

FIG. 2 shows an example of a screen shot that is presented after the attendee selects the profile navigation tag shown in FIG. 1.

FIG. 3 shows an example of a screen shot that is presented after the attendee selects the recommendations tag shown in FIG. 1.

FIG. 4 shows an example of a screen shot that is presented after the attendee selects the map tag shown in FIG. 1.

FIG. 5 shows an example of a screen shot that is presented after the attendee selects the “other conferences” tag shown in FIG. 1.

FIG. 6 illustrates an example of an environment in which clients communicate with the conference networking system over the Internet or any other packet-based wide-area network.

### DETAILED DESCRIPTION

Conferences provide a channel for people to network and create business relationships and connections. That is, conferences can be excellent places for physical networking. However, many people are unable to connect with the right people and make best use of their conference experience. This is primarily because information about the attendees is often only available upon arrival at the conference and there is no convenient process available for enabling attendees to discover people prior to and during the conference.

In contrast to conferences at which people physically network, the recent popularity of social networking web sites allow people to virtually network with one another. Social networking web sites allow a subscriber to create a personal web page including pictures, text and perhaps video, of things relevant to the subscriber. Other subscribers to the social networking web site are able to search for and view the personal web page and initiate contact with the subscriber. Social networking web sites allow groups of people to congregate on websites based on common interests or goals, and as a result create virtual online communities. In some cases members of such online communities will choose or pre-approve other members before they are allowed to join the community or sub-community on the web site. Notably, subscribers can establish networks of favorite “friends”. Favorite friends can be specified manually by a given subscriber and often represent the individuals or organizations most favored by the given subscriber. Each of the favorite friends can be presented in the web site so as to allow linking to a corresponding profile for the favorite friend. In this way, an end user literally can navigate the social network for a given subscriber.

As detailed below, a system, method and apparatus is provided to enable conference attendees to leverage the power of social networking tools to discover, connect and collaborate with other attendees prior to, during and after the conference. The specific examples described herein represent illustrative instances of such a system, method and apparatus and thus should not be construed as being restrictive in nature.

A system providing an on-line conference networking service may allow, for instance, at least three different user groups to interact. The different user groups in this example are a system administrator, conference organizers, and conference attendees. The system administrator establishes the on-line service and solicits various conference organizers to participate in their service. The system administrator will typically have full control of every aspect of the system. This potentially includes access to all hardware, software, and data components. The system administrator may offer the service as single, stand-alone service, or alternatively, as part of a suite of Internet services. As an example of the latter offering, the suite of services may be those made available through the Windows Live products for which Microsoft is the system administrator. If the system administrator offers a suite of web-based services, the online conference networking service may be promoted on the administrator's various web sites and may provide a link so that users can directly connect to the conference networking web site. The conference organizers may execute a number of actions through the on-line service. Conferences may be set up, viewed, edited and deleted. Events and meetings that are to take place during the conference may be similarly scheduled, using set-up, view, edit and delete options available through an interface associated with the on-line service's web site. Requirements and preferences of events and users may also be adjusted. Thus, events may be adjusted by the conference organizer to alter name, time, location, attendance list, etc. Similarly, user information may be adjusted—changing password, account information, personal information, even allowing the conference organizer to effectively become a user within the system. Broadcast information may also be affected by the conference organizer. Thus, advertising may be selected, added, viewed, edited, deleted, or broadcast properties may be set. Similarly, announcements may be created, broadcast, or altered, for example. It should be noted that many of these actions performed by the conference organizer may be alternatively performed by the system administrator. In some cases the conference organizer and the system administrator may have overlapping capabilities to perform one or more of these actions.

The conference organizer may also adjust specific information about the conference. For example, attendance information may be adjusted. Thus, a list of attendees may be accessed and access control for that list may occur—e.g. other user's access to the list of attendees may be controlled. Moreover, subsets of the attendee list may be created, with various users assigned to such a list and various users given access to the list. Similarly, conference requirements can be set or modified. Thus, events that are to take place at the conference may be added and altered. Similarly, the conference organizer can add, delete and view user information and user account information for an event. In addition, a conference map may be created, loaded, and edited as appropriate to reflect the physical layout of a conference and changes thereto. Moreover, rooms may be selected and altered for meetings or events.

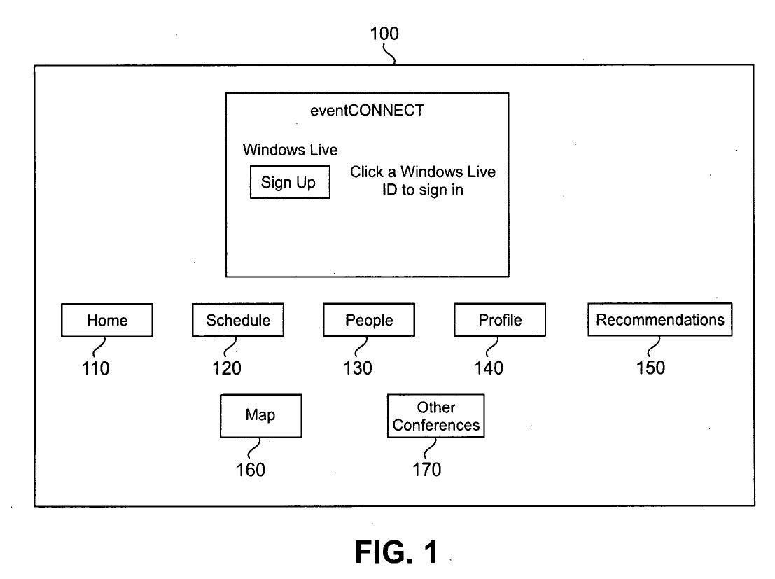

As with other users, attendees, who represent the third of the user groups mentioned above, may login and logout of the network. FIG. 1 shows one example of a screen shot of a web page that may be presented to an attendee. The web page will generally be presented after the attendee has logged in to the system, either through the system administrator's web site or the conference organizer's web site. In this example the attendee is logged in through the system administrator's web site, which in this example is the Windows Live web site operated by Microsoft. By logging in, users may add, delete and edit their own account information and establish a personal profile while controlling who else may access such information. Also, such users may schedule personal meetings, add personal contacts, and view the overall attendees list as authorized. Likewise, such users may view general conference information such as maps, lists of booths and events, directions, etc. Moreover, such users may set advertising preferences and may view advertisements. Examples of some of these capabilities will be presented below.

The screen shot 100 shown in FIG. 1 presents a menu bar that includes a series of navigation tags 110, 120, 130, 140, 150, 160 and 170. In this example, as well as in others that follow, the conference networking service is illustratively associated with Windows Live and is referred to as “eventCONNECT.” Selection of the navigation tags may bring up items such as a schedule view, a people view, a profile view, a recommendations view, an other conferences view and a map view. The schedule view provides a list of events occurring at the conference in chronological order. The events may be presented in a fashion similar to a calendar application. When an event is clicked on information about the event may cover, for example, a portion of the screen. One piece of included information may be the room for the event. If the user clicks on the room information, the portion of the screen with the event information may be replaced with the map and the room in question will be marked with an X or other indicator.

If the attendee selects the people tag 130 in FIG. 1 a list of attendees will be provided, possibly along with various items such as their corporate affiliation, job title and the like. This information will be obtained from the attendees' profiles, which will be discussed below. The attendee may also be able to search for individual attendees that meet criteria of interest to the attendee. This may be accomplished by searching the profiles of the attendees. The attendee may also be provided with a link to the individual attendees that have been identified in order to send messages or otherwise establish communication with them by any appropriate means.

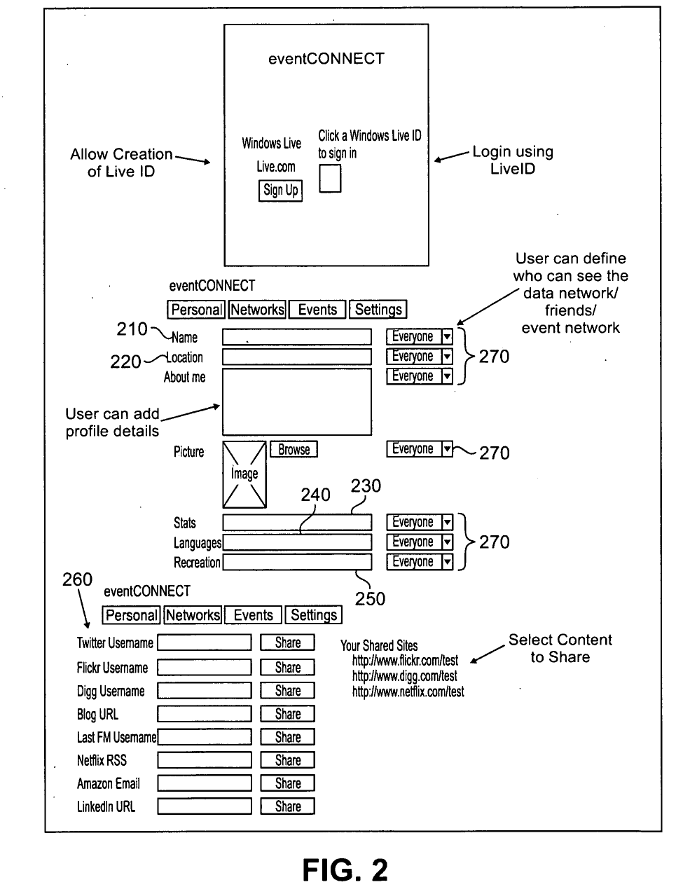

If the attendee selects the profile navigation tag 140 shown in FIG. 1, a web page may be presented that allows the attendee to establish his or her own personal profile. An example of a screen shot 200 of such a web page is shown in FIG. 2. The attendee constructs his or her personal profile by populating various fields 210, 220, 230, 240, 250 and 260 the web page. For instance, in addition to such basic information as name, contact addresses, job title, professional affiliations and the like, other fields may allow the attendee to specify special skills, languages spoken, professional and recreational interests and so on. In addition, the attendee may enter one or more usernames that he or she uses on various social networking sites. Each username provides a link to the attendee's profile on a different social networking site. Examples of such sites include, without limitation, Facebook, Twitter, Flickr, Digg, Netflix, Amazon and Linkedin. By providing these usernames the attendee can share with other attendees additional information about him or herself that is available on the social networking sites. Such additional information may include friends and other individuals for which the attendee has provided links. In this way these friends and individuals may become a part of the network of individuals who can be searched and identified by the conference attendees and who may be invited to upcoming conferences, particular events occurring at the conference and people who will be attending the conference. The attendee profile that results from aggregating the profile created specifically for the conference along with the profile or profiles available on the social networking site(s) can provide a rich set of information that may be made available to the conference organizer and other attendees.

Each field in the attendee's profile may be shared with all other attendees or only with various subsets of attendees by appropriate selection from a pulldown menu 270 associated with the various fields.

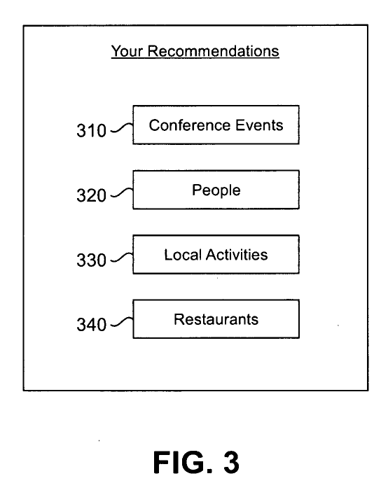

Once the attendee's profile is complete the data contained therein (including data contained in the attendee's social networking profile(s)) may serve as metadata or tags that can be searched by other attendees or used by the on-line system to make various recommendations of events and activities that may be of interest to the attendee. For instance, as shown in FIG. 3, by clicking on the recommendations tag 150 in FIG. 1 the attendee may select from among a variety of categories on a recommendations page. In this example the categories include conference events 310, people (e.g., other attendees), 320, local activities (e.g., museums, sporting events) 330 and restaurants 340. The items in each of these categories will have been provided by the conference organizer prior to the start of the conference. By selecting one of the categories the attendee may view recommendations that have been tailored to his or her interests based on the metadata available from the attendee's profile. The recommendations may also be tailored so that they do not conflict with other events that the attendee has already scheduled.

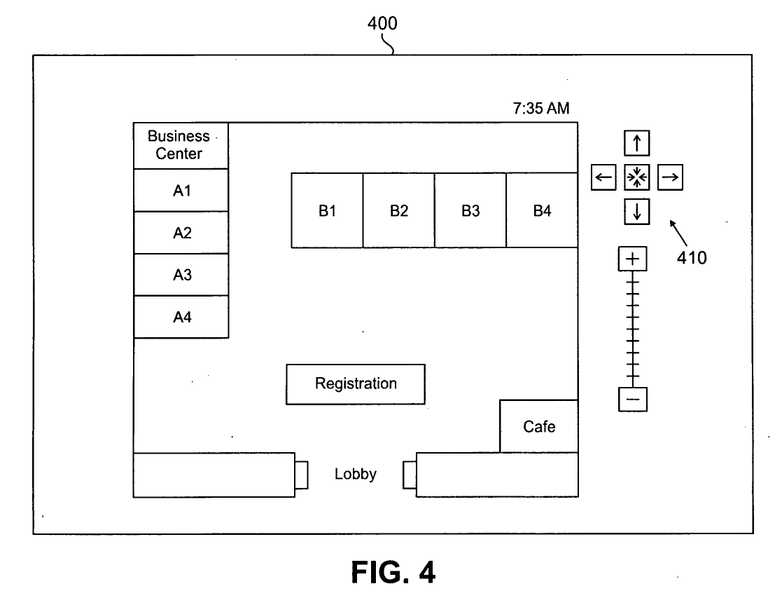

If the attendee selects the map navigation tag 160 shown in FIG. 1, a map 400 of the conference site (e.g., a hotel or convention center floor plan) will be presented, an example of which is shown in FIG. 4. The attendee can scroll on the map by dragging, or zoom in/out by clicking the ‘zoom in’ and ‘zoom out’ buttons 410. The rooms may be labeled on the map. When the user clicks on a room, details about the event currently happening in that room may be displayed. Details concerning other events occurring in that room later in the day or on another day may also be presented. In some cases these additional details will cover a portion of the screen so that the remaining portion of the screen is available for the map. The map may also provide an indication of where the user is currently located. This information may be available if the user has a GPS-enabled device that is registered with the system.

In addition to a map of the conference site, other maps may be available. For example, a map of the surrounding area may be provided to show the location of various off-site activities, restaurants and the like.

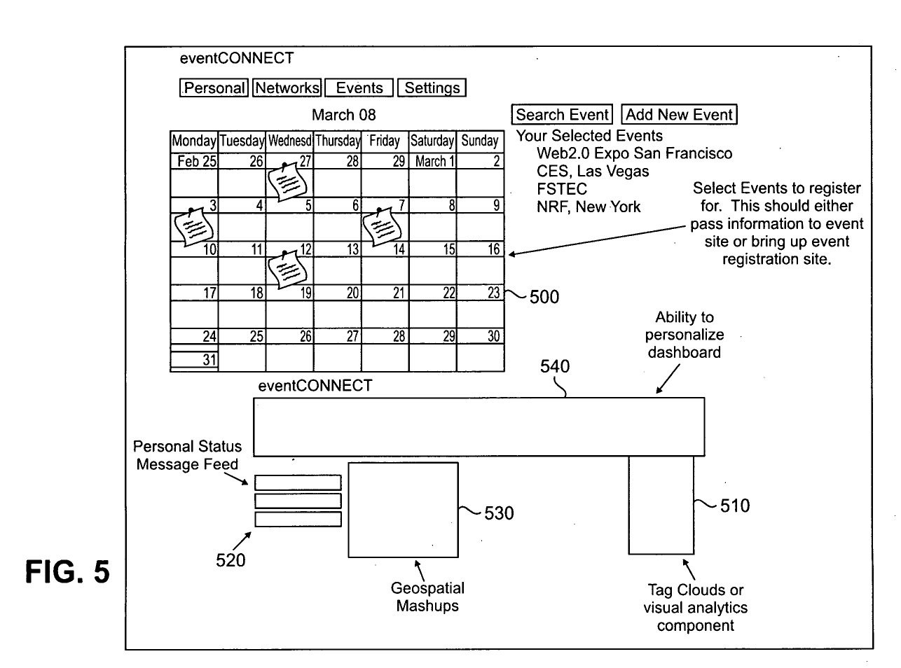

If the attendee selects the other conferences navigation tag 170 shown in FIG. 1, a calendar 500 such as shown in FIG. 5 may be presented to the attendee. The calendar 500 identifies other conferences registered with the on-line service which may be of interest to the attendee, based on the attendee's profile. The calendar 500 shows the dates on which these conferences will be occurring. By clicking on any of the dates the attendee may receive additional information about the conference and also may be given an opportunity to register for the conference by directing the attendee to the registration web site. The user may also search for particular conference using a search icon. In addition to the calendar, the web page shown in FIG. 5 may also present other information to the user. For instance, a list 510 of other individuals who have already registered for the conferences may be presented, along with the selected items from their profile. Additionally, a personal message feed 520 may be available in which other individuals (such as those individuals who have already registered for some of the conferences or individual who are considering registering) may contact the attendee, perhaps to recommend certain conferences to him or her, or for any other reason. A map 530 may also be provided on the same page as the calendar, showing the geographic location (e.g., country, state, city) of the conferences that are displayed on the calendar. Additional fields such as field 540 may be provided, which may include customized information selected by the attendee.

In some cases users may be able to download various plug-ins that offer additional functionality to enhance the on-line conference networking system. For example, a plug-in may be available that allows the user to transfer the conference dates from the calendar shown in FIG. 5 to the calendar in the user's own personal information manager (e.g., Microsoft Outlook).

In some implementations when the attendees arrive at the conference they will be given an ID badge upon registration which includes a barcode. Among other things, the barcode may include a URL associated with the respective attendee's profile. When two attendees meet during the conference, they can exchange information by scanning or otherwise imaging the others barcode using a portable device such as a PDA, mobile phone and the like. The portable device may include a mobile version of the on-line conference networking application. The barcode may be a quick response (QR) code, which is a two-dimensional barcode. Of course, the barcode may also be a one-dimensional barcode.

An attendee may use the on-line system to perform a wide variety of tasks, a few of which are summarized below.

1. The attendee can search for a particular person having a particular trait by searching the profiles or metadata of other attendees.

2. The attendee can discover an interesting person at a conference through a recommendation provided by the system.

3. The attendee can discover local restaurants and activities based on his or her profile, including any profiles associated with a social networking site, if the attendee has made such profiles available.

4. The attendee can discover interesting events or sessions at the conference based on his or her profile, including any profiles associated with a social networking site, if the attendee has made such profiles available.

5. The attendee can schedule a meeting with another attendee or a group of attendees after they both attend an event or session at the conference.

6. The attendee can schedule a meeting with another attendee at a local restaurant recommended by the system.

7. The attendee can discover local restaurants and activities based on his or her profile, including his or her social networking profile(s).

8. The attendee may be introduced to a potential customer through another person via the system.

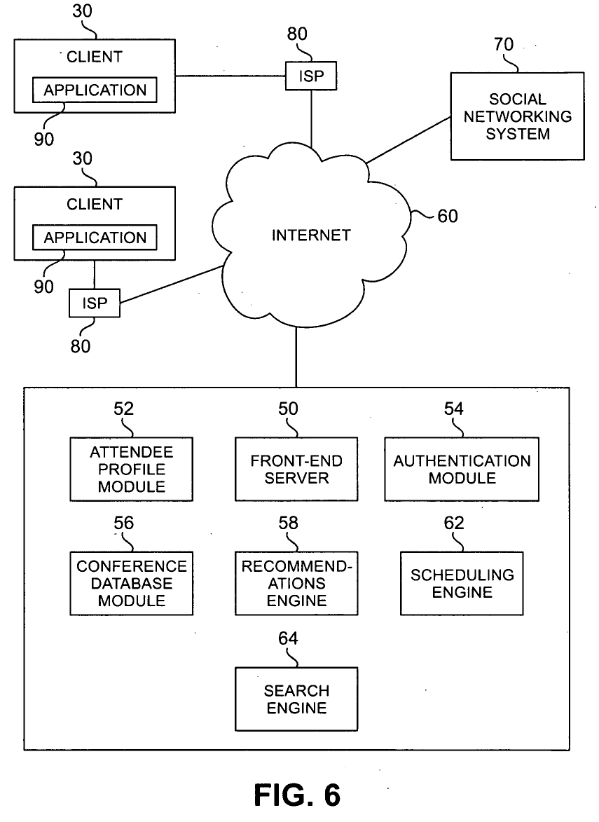

FIG. 6 illustrates an example of an environment in which clients 90 communicate with the conference networking system 20 over the Internet 60 or any other packet-based wide-area network. The client 90 is connected to the Internet via one of many available Internet Service Providers (ISPs) 80. Cloud 30 is labeled the Internet, but it is understood that this cloud represents that portion of the Internet 30 that does not include the system 20, the client's ISP 80, and the client 90. However, it should be noted that from the client's perspective the system 20 or other device or service with which the client communicates is often viewed as being inside the cloud. Inside such a cloud are the routers, transmission lines, connections, and other devices that transmit data between clients and servers. Also shown in FIG. 6 is a social networking system 70 of the type previously mentioned.

The clients 90 access and interact with the conference networking system using an application 30, which may be a client-based or Internet-based application or an application that is in part client-based and in part Internet-based. In the FIG. 6 the application 30 is shown as a client-based application. In other words, the functionality of the application could be provided as part of a service or as a client-resident program.

The conference networking system 20, shown in terms of logical or functional blocks in FIG. 6, typically includes one or more physical server computers with one or more physical storage devices and/or databases as well as various processing engines. In the example of FIG. 6 the conference networking system 20 includes a front-end server 50 that executes one or more applications that provide a service to the clients 90. The front-end server 50 also establishes communication with and share information with the social networking sites such as social networking system 70. The conference networking system 20 also includes an attendee profile module 52, an authentication module 54, a conference database module 56, a recommendation engine, a search engine 64 and a scheduling engine. The attendee profile module 52 acquires, stores and makes available for searching the attendee profiles. In addition, the attendee profile module 52 may also store the conferences, events and activities that are scheduled by the attendees. The authentication module 54 authorizes and authenticates the various users of the system, including attendees and conference organizers. The conference database module 56 acquires, stores and makes available for searching the information concerning the individual conferences supplied by the conference organizers. The recommendations engine 58 generates recommendations using the information in the attendee profile module 52 and the conference database module 56. The search engine 64 responds to user requests by searching the attendee profile module 52 and the conference database module 56. The scheduling engine 62 schedules events and activities for the individual attendees and ensures that conflicts do not arise by comparing events and activities that an attendee wishes to schedule with events and activities that have already been scheduled.

1. A method for facilitating networking among attendees at a conference, comprising:
receiving over a wide-area network a user profile from a user who has registered for at least one conference selected from among a plurality of conferences, wherein the user profile includes a username for at least one social networking site;
storing the user profile in a database that includes a plurality of user profiles for a plurality of attendees who have registered for at least one of the plurality of conferences; and
granting the user access to the database over the wide-area network, including access to a profile on the social networking site associated with the username.

2. The method of claim 1 further comprising:
receiving over the wide-area network information pertaining to each of the plurality of conferences from one or more conference organizers of the conferences;
storing the information in a second database; and
granting the user access to the information in the second database.

3. The method of claim 2 wherein the information includes a time, place and subject matter associated with at least one event to take place during each of the conferences.

4. The method of claim 2 wherein the information further includes recreational activities available to attendees of at least one of the conferences.

5. The method of claim 1 further comprising presenting, upon user request, a conference map to the user on which event location information is included.

6. The method of claim 1 wherein the user profile includes a plurality of fields populated by the user, and further comprising restricting access to each of the fields based on user preference.

7. The method of claim 6 wherein different fields are restricted to different subsets of conference attendees.

8. The method of claim 1 further comprising:
receiving a search request from the user to identify at least one individual who meets at least one criterion specified by the user;
searching the database to identify any individuals who have a user profile that meets the at least one criterion;
presenting to the user over the wide-area network contact information for any individuals who are identified.

9. The method of claim 8 wherein the individual is a conference attendee.

10. The method of claim 8 wherein the individual is associated with a conference attendee through the social networking site and further wherein searching the database includes searching the social networking site to identify the individual using social networking usernames of the conference attendees.

11. The method of claim 1 wherein the user profile includes a professional affiliation of the user and at least one recreational interest of the user.

12. The method of claim 2 further comprising recommending to the user at least one event, activity or attendee associated with the at least one conference based at least in part on the user profile and the information pertaining to the at least one conference received from the conference organizer.

13. The method of claim 1 further comprising recommending to the user other conferences of potential interest based on the user profile.

14. The method of claim 1 further comprising presenting, upon user request, a calendar on which the plurality of conferences are included.

15. The method of claim 1 further comprising presenting a link on a web page that offers users a first service, the link connecting users to a second web page through which they can access the conference networking service that facilitates networking among the attendees at the conference.

16. A conference networking system, comprising:
a server having a network interface for establishing communication over a wide-area network;
a first database configured to store information pertaining to a plurality of conferences;
a second database configured to store information including a plurality of user profiles of conference attendees of each conference, at least one of the user profiles including a username for at least one social networking site; and
a search engine for searching the first and second databases and a second user profile on the social networking site associated with the username.

17. The conference networking system of claim 16 further comprising a recommendation engine for generating recommendations tailored to individual conference attendees based at least in part on their respective user profiles.

18. The conference networking system of claim 17 wherein the recommendations include at least one event, activity or conference attendee associated with one of the conferences.

19. The conference networking system of claim 18 wherein the recommendations further include an individual associated with the conference attendee through the social networking site.

20. The conference networking system of claim 16 wherein the server presents a calendar on which the plurality of conferences are included.
